(19) United States
(12) Patent Application Publication
(10) Pub. No.: US 2017/0341800 A1
(43) Pub. Date: Nov. 30, 2017

(54) CONTAINER MADE FROM THERMOPLASTIC POLYMER AND METHOD FOR PRODUCING SAID CONTAINER

(71) Applicant: KAUTEX TEXTRON GMBH & CO. KG, Bonn (DE)

(72) Inventors: Klaus GEBERT, Willich (DE); Daniel MARX, Bedburg (DE); Marlappan THIRUGNANASAMBANDAM, Woraiynur, Trichly (IN)

(21) Appl. No.: 15/535,974

(22) PCT Filed: Dec. 10, 2015
(86) PCT No.: PCT/EP2015/079308

§ 371 Date: Jun. 14, 2017

(30) Foreign Application Priority Data
Dec. 15, 2014 (DE) 10 2014 118 654.0

(51) Int. Cl. B65D 1/44; B29C 49/22; B29C 49/42; B29C 49/48; B65D 1/02; B29C 49/04; B29C 49/00; B60K 15/03; B29K 105/00; B29K 701/12; B29L 31/00

(52) U.S. Cl. CPC B65D 1/44; B29C 49/04; B29C 49/22; B29C 49/4268; B29C 49/4802; B29C 49/0047; B65D 1/02; B29C 2049/0057; B29K 2105/256; B29K 2701/12; B29L 2031/7172; B60K 15/03177; B60K 2015/03046; B60K 2015/03493; B29K 2105/258

(57) ABSTRACT

The invention relates to a container made from thermoplastic polymer with at least one inner reinforcing rib in a container wall, wherein the reinforcing rib is formed by at least one linear groove track in a container outer wall, the groove track extends over a length on the container outer wall, the groove track is formed by a multiplicity of depressions in the container outer wall, said depressions being arranged at a distance from one another, and wherein material bridges are provided between each of the depressions, said material bridges each having a smaller depth than the depressions. The invention furthermore relates to a method for producing such a container by extrusion blow molding or thermoforming.

### FIELD

The invention relates to a container made from thermoplastic polymer with at least one inner reinforcing rib in a container wall.

The invention furthermore relates to a method for producing such a container.

### BACKGROUND

It is basically known to provide containers made from thermoplastic polymer with reinforcing ribs which increase the flexural rigidity and the compressive strength of the container walls. In the case of bottles, it is known, for example, to provide said bottles with peripheral reinforcing ribs. In the case of injection-molded containers, it is known to integrally form reinforcing ribs on the container walls. Such reinforcing ribs can be designed in such a manner that they protrude into the container volume and are consequently also at the expense of the container volume. As an alternative thereto, reinforcing ribs can be provided on the outside of the container walls, but this could be obstructive depending on the intended purpose of the container. In the case of containers made from injection-molded polymer, additional reinforcing ribs or other reinforcing geometries are material accumulations in the container wall that may lead to sink marks on the container. Said sink marks arise due to slower cooling of the material in the region of the thick points of the container after the manufacturing of the container and are frequently not desirable visually. Furthermore, such material accumulations are associated with an increased consumption of polymer material and significantly increase the container weight.

In order to limit the deformation of containers, oblique wedges are nowadays introduced into the container wall, said wedges projecting from a stiff region on the side wall into the deforming surface. The effect and the usability are limited and there is an associated great loss of useful volume.

In the case of sheet-metal containers, it is basically known to provide rectilinearly extending beads which optionally cross one another in the container walls. However, such stabilization measures cannot be transferred, for example, to the production of extrusion blow-molded hollow bodies made from thermoplastic polymer. In the case of extrusion blow-molded containers made from thermoplastic polymer, beads act as an expansion bellows which increases the deformability of the container under pressure.

JP H 08 197614 A discloses a method for the extrusion blow molding of hollow bodies, in which the preform is impressed from the outside by means of elements, which have projections, in such a manner that the opposite walls of the hollow body are connected to one another by means of material bridges.

A comparable method is known from WO 2013/133859 A1.

### SUMMARY

The invention is based on the object of providing a container made from thermoplastic polymer, which is provided with at least one reinforcing rib which, with as little loss of volume as possible and as low a use of material as possible, brings about an effective reinforcement of the container.

The invention is furthermore based on the object of providing a suitable method for producing such a container.

Moreover, the container according to the invention is intended to be designed as a large-volume container which has reinforced extensive walls. Such containers are, for example, fuel tanks, oil containers, wiping water containers or additive containers which can be obtained by extrusion blow molding.

The container according to the invention is intended in particular to be weight-optimized.

The object is achieved with the features of claim 1 and with the features of the further independent method claim. Advantageous refinements of the invention emerge from the dependent claims.

According to one aspect of the invention, a container made from thermoplastic polymer with at least one inner reinforcing rib in a container wall is provided, wherein the reinforcing rib is formed by at least one linear groove track in a container outer wall, the groove track extends over a length on the container outer wall, the groove track is formed by a multiplicity of depressions in the container outer wall, said depressions being arranged at a distance from one another, and wherein material bridges are provided between each of the depressions, said material bridges each having a smaller depth than the depressions.

Inner reinforcing rib within the context of the invention means that the reinforcing rib protrudes into the volume of the container.

The container according to the invention can be a large-volume container which has at least two container walls which are extensive in relation to the remaining container walls and which can be arranged, for example, opposite each other. At least one reinforcing rib, preferably a plurality of reinforcing ribs, is or are provided in at least one of the extensive container walls. The reinforcing rib extends linearly or is designed as a linear groove track.

A groove track within the context of the present application is a track of a plurality of groove portions or depressions arranged linearly at a distance from one another in the container outer wall. The groove track can basically extend rectilinearly; alternatively, the groove track can be arranged in a curved manner. The groove track according to the invention is formed by a multiplicity of depressions or groove portions arranged linearly at a distance from one another in the container outer wall.

It is basically possible to provide the groove track by means of a multiplicity of depressions in the container inner wall; however, the arrangement of the groove track in the container outer wall is preferred, and therefore the resulting reinforcing rib is at the expense of the container volume.

The material bridges formed between each of the depressions in the container wall have a smaller depth than the depression, wherein the material bridge can basically be aligned with a surface of the container outer wall outside the groove track. However, it is basically also within the context of the invention that the material bridge, for its part, are designed as depressions of the container outer wall which then, however, have a smaller depth than the depressions.

The solution according to the invention has the advantage that a container designed in this manner can be produced by extrusion blow molding, in particular since the depressions are provided in the container outer wall. In comparison to an uninterrupted groove, a groove track having a multiplicity of depressions spaced apart from one another and material bridges provided between the depressions has the advantage the said groove track does not form any weakening of the container wall in the sense of a notch or in the sense of a bead and therefore actually contributes to a considerable stabilization of the container wall even in the case of a container made from thermoplastic polymer. Owing to the fact that the groove track is not designed as a continuous rib, but on the contrary is interrupted by means of material bridges, the advantage furthermore also arises that the reduction in the useful volume of the container is kept within justifiable limits in comparison to a continuous reinforcing rib in the interior of the container. The width of the depressions can be relatively small in relation to the length of the depressions.

In the case of the container according to the invention, it is provided that the polymer of the container wall is accumulated in the region of the material bridges, and therefore the wall thickness of the container wall is greater in the region of the material bridges than in the region of the depressions.

Particularly preferably, the wall thickness of the container wall is greater in the region of the material bridges than the wall thickness of the container wall outside the groove track, and therefore the material bridges each form thickenings of the container wall which ultimately lead to a considerable stabilization of the container wall in said regions. Such thickenings can be at the expense of the wall thickness of the container wall in the region of the depressions where a thinner wall thickness is significantly less critical because of the smaller wall surfaces, and therefore, overall, the production of the container according to the invention requires scarcely any more outlay on material. The container weight can therefore correspond to the container weight of a container without reinforcing ribs and with a substantially identical average wall thickness.

Particularly preferably, the depressions have a length and a width, wherein it is provided that the length is 4 to 7 times the width of the depressions. For example, the material bridges can have a length which is 0.3 times to 0.5 times the length of the depressions.

In this connection, length means an extent in the direction of the groove track and width means an extent transversely with respect thereto.

The depressions are expediently arranged at regular and identical distances from one another.

The material bridges can have a length which is smaller than or equal to twice the wall thickness of the container outside the groove track.

A plurality of reinforcing ribs, preferably in the form of a plurality of rectilinearly extending groove tracks which preferably cross one another can be provided in the container wall. The groove tracks can be, for example, of X-, T- or S-shaped design. Said groove tracks reinforce the container wall transversely with respect to its extensive extent.

A further aspect of the invention relates to a method for producing a container with one or more of the previously described features, wherein the method is distinguished in that the container is obtained by extrusion blow molding or thermoforming of at least one preform made from thermoplastic polymer, wherein the method comprises the providing or the extruding of the preform, the introducing of the plasticized preform into a tool and the deforming and shaping of the preform within the tool, wherein at least one reinforcing rib in the form of a linear groove track is produced during the shaping of the container within the closed tool by means of at least one tool insert or a tool slide designed as a rib-shaped strip which protrudes into a cavity of the tool, wherein the strip has a multiplicity of grooves and webs, and wherein the webs produce depressions in the container outer wall and plasticized polymer is accumulated in the webs.

A preform within the context of the present invention can be a tubular preform which is deformed in the first heat of the extruded polymer, that is to say using the plasticization heat of the polymer within a multi-part blow molding tool. However, the method may comprise the extrusion blow molding in the sense of a two sheet blow molding method in which either twin strip-shaped, plasticized preforms are extruded and are deformed and shaped in a multi-part blow molding tool. Such a method can also comprise the providing of a tubular preform which is divided longitudinally on opposite sides and the parts of which are configured to form strip-shaped preforms.

A blow molding tool within the context of the present invention preferably comprises two or more blow molding parts which each have cavities and are movable with respect to one another and are bringable into contact against one another on what is referred to as a clamping frame. When the blow molding tool is closed, the cavities of the parts of blow molding tool form a mold cavity, the boundary contour of which substantially corresponds to the outer contour of the container to be manufactured.

The preform or the preforms is or are deformed and shaped either by gas pressurization of the mold cavity or by evacuation of the mold cavity or by gas pressurization of the mold cavity and evacuation of the mold cavity. The tool insert (stationary) or the tool slide (retractable into the cavity and extendible out of the latter) is expediently designed as a comb-like strip with grooves and webs located in between.

A thermoforming tool can also be provided as the tool within the context of the invention, wherein, in this case, the method comprises the heating and plasticizing of two semi-finished products made from thermoplastic polymer as preforms, and the semi-finished products are each deformed and shaped in a tool and subsequently joined to form the container.

According to the invention, the grooves have a length, a width and a depth. The length of the grooves corresponds approximately to the length of the material bridges, and the length of the grooves is dimensioned in such a manner that the wall thickness of the shaped container is greater in the region of the material bridges than the wall thickness of the container in the region of the depression, and is preferably greater than outside the groove track.

In this context, length means an extent in the direction of the extent of the strip, whereas width means an extent transversely with respect thereto.

Steep-walled reinforcing ribs can thereby be introduced into the container from the outside, for example via rigid “blades” as tool insert or tool slide in the blow mold or in a thermoforming tool which can ideally be demolded in the direction of the tool opening. The tool insert or the tool slide can be designed as a comb-like or rib-shaped strip, this having the effect that, for example during the blow molding process, melt from both sides of an arising bulge can pass through and the materials of the preform or of the subsequent container wall can be connected to one another from both sides. The length of the grooves here is ideally dimensioned in such a manner that the plasticized material of the preform cannot fully penetrate the groove base, that, on the contrary, a fold of the preform forms, in which the container wall is of “double-layered” design and material bridges or material thickenings thus arise between the webs. The polymer accumulated in this manner forms material bridges which bring about stiffening of the groove track. The length of the grooves is preferably configured in such a manner that, as already mentioned above, the preform does not fully dip into the profile of the rib-shaped strip and is connected together on both sides of the webs.

The penetration of the polymer into the grooves or into the profile of the strip can basically be made more difficult by a metal wire or a polymer cord being placed over the strip and penetrating into the plastic polymer of the preform during the production of the container and being lost therein.

In a preferred variant of the method according to the invention, it is provided that the length of the grooves is between 1.8 times and 4 times the wall thickness of the preform. During the shaping of the groove track, the plasticized material flowing around the strip is stretched in the region of the subsequent depressions and is compressed in the region of the subsequent material bridges.

### BRIEF DESCRIPTION OF THE DRAWINGS

The invention is explained below with reference to an exemplary embodiment which is illustrated in the drawings, in which:

FIG. 1 shows a perspective illustration of a container according to the invention, which is designed as a fuel tank;

FIG. 2 shows a schematic illustration of a part of an opened blow molding tool;

FIG. 3 shows a perspective illustration of a reinforcing rib in the interior of the container;

FIG. 4 shows a top view of the cavity of a blow molding tool;

FIG. 5 shows a side view of a tool insert for producing the reinforcing rib; and

FIG. 6 shows an end side view of the tool insert in the blow molding tool.

### DETAILED DESCRIPTION

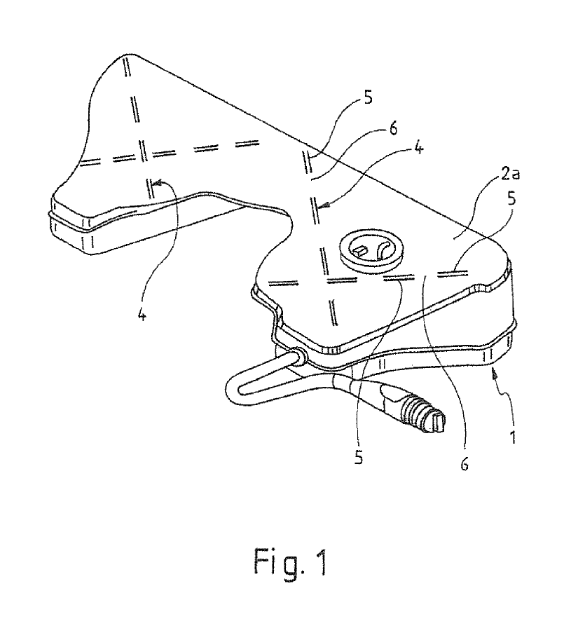

FIG. 1 shows a container (1) according to the invention, which is designed, for example, as a fuel tank for a motor vehicle. The container 1 is composed of thermoplastic polymer and has been produced by extrusion blow molding of a preferably multi-layered extrudate on the basis of polyethylene. The invention should basically be understood in such a manner that the container 1 can have also been produced as what is referred to as a monolayer container on the basis of a single-layered extrudate made from thermoplastic polymer. The container 1 comprises a container wall 2 which encloses a filling volume. In the exemplary embodiment illustrated in FIG. 1, the container 1 is designed as what is referred to as a saddle tank with two chambers which communicate with each other, but the invention should be understood in such a manner that the container 1 can have any configuration. The container 1 can have been shaped, for example, as a simple cuboidal or cube-shaped structure.

The container wall 2 of the container 1 can have relatively extensive wall regions which are provided with reinforcing ribs 3 protruding into the container volume.

In the example according to FIG. 1, the reinforcing ribs 3 are formed by substantially rectilinearly extending groove tracks 4 in the container outer wall 2a. The groove tracks 4 are in each case of linear and rectilinearly extending design, wherein in each case two groove tracks 4 cross each other approximately at a right angle.

The groove tracks 4 are formed by a multiplicity of depressions 5 in the container outer wall 2a, which depressions are arranged at a distance from one another, wherein material bridges 6 are provided between each of the depressions 5, said material bridges each having a smaller depth than the depressions 5.

The depressions 5 have been produced during the production of the container 1 by means of impressions in the container outer wall 2a.

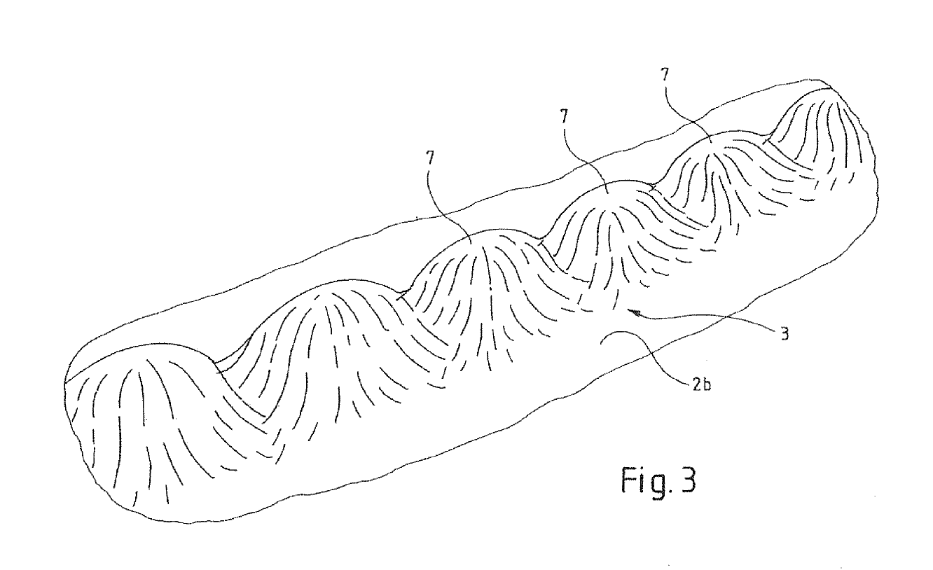

FIG. 3 shows the design of a reinforcing rib 3 on a container inner wall 2b, at which each depression 5 in the container outer wall 2a produces a corresponding projection 7.

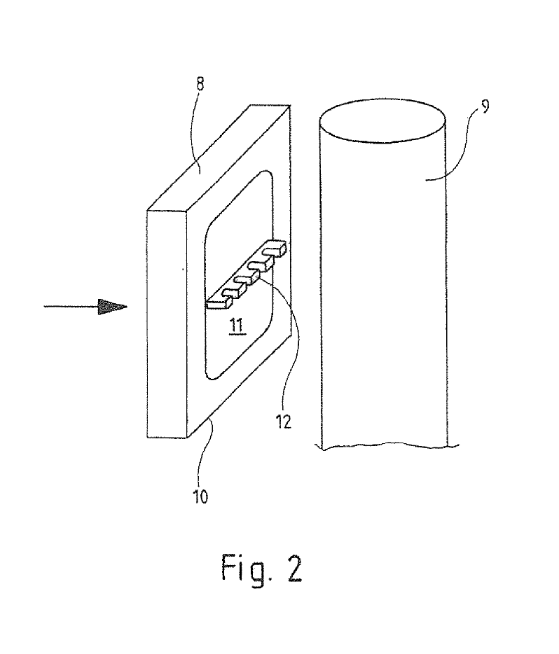

The method for the production of the container 1 according to the invention is explained below with reference to FIGS. 2 to 6.

FIG. 2 shows, purely schematically, an open blow mold half 8 of a blow molding tool (not illustrated completely) and a preform 9 which is made from thermoplastic polymer and is placed with respect to the blow mold half 8. The container 1 can have been produced, for example, by conventional extrusion blow molding of a preform 9 of tubular design, wherein the preform 9 can have been extruded suspended in single- or multi-layered form by means of an extrusion head arranged above the blow molding tool. The blow molding tool can comprise, for example, two blow molding halves 8 which can undertake an opening and closing movement on a clamping frame (not illustrated). The term blow molding half 8 comprises a customary mold clamping platen and a tool part 10 which is arranged on the mold clamping platen and has a cavity 11 which defines a part of the outer contour of the container 1 to be manufactured.

The cavities 11 of two blow molding halves 8 can form, for example, a closed mold cavity, wherein the contour of the mold cavity corresponds to the configuration of the complete container 1 to be manufactured.

As already mentioned at the beginning, the blow molding tool can comprise more than two tool parts 10, the production method can be configured, for example, as what is referred to as a twin sheet blow molding method in which strip-shaped preforms are deformed in a three-part blow molding tool

For example, a tool insert which is designed as a rib-shaped strip 12 is provided within the cavity 11 of the tool part 10. The strip 12 comprises a multiplicity of grooves 13 and webs 14, wherein the webs 14 produce the depressions 5 in the container outer wall 2a and the material bridges 6 are formed in the grooves 13.

The method first of all comprises providing or extruding the preform 9, placing the preform between the open blow molding halves 8 of the blow molding tool or extruding the preform 9 between the open blow molding halves 8 in the direction of gravity. The blow molding halves 8 are closed around the preform 9, the preform 9 is expanded within the mold cavity formed by the cavities 11 and, in the process, is deformed and shaped against the walls of the cavities 11. The preform 9 is placed here against the rib-shaped strip 12 designed as a tool insert and produces a reinforcing rib 3 of the type shown in FIG. 3. The rib-shaped strip 12 has a thickness and a length, wherein the strip 12 is interrupted along the length by the grooves 13, and the webs 14 arranged between the grooves 13 have a length which is dimensioned in such a manner that the preform 9, during the shaping within the blow molding tool or during the expansion thereof, for example by means of blowing air, does not completely enter the grooves 13 of the strip 12 and is connected together on both sides of a web 14, and therefore material bridges 6 in the form of thick points are formed in the container wall 2.

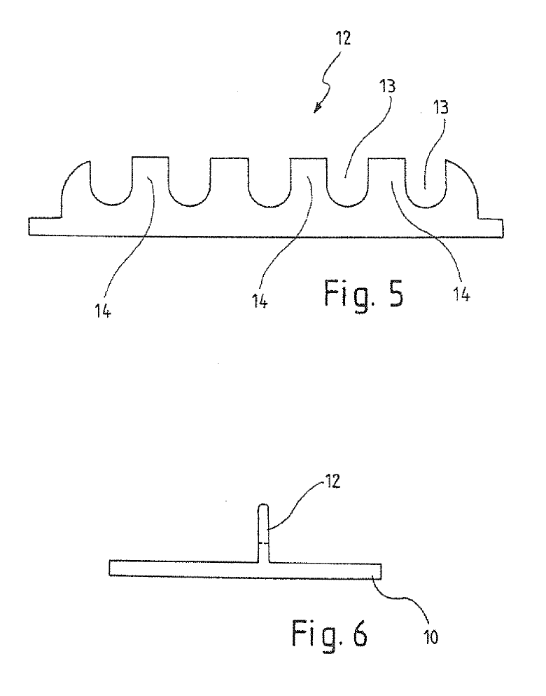

As can be gathered in particular from the overall view of FIGS. 5 and 6, which shows a strip 12 according to the invention, the thickness of the strip 12 is approximately only one quarter of the length of the grooves 13, and therefore the preform, as it flows around the strip 12 during its shaping, is connected together not only by two sides of a web 14, which sides lie opposite each other in the longitudinal direction of the strip 12, but also a connection of the preform in the direction of the thickness of the strip 12, i.e. transversely with respect thereto, is also obtained.

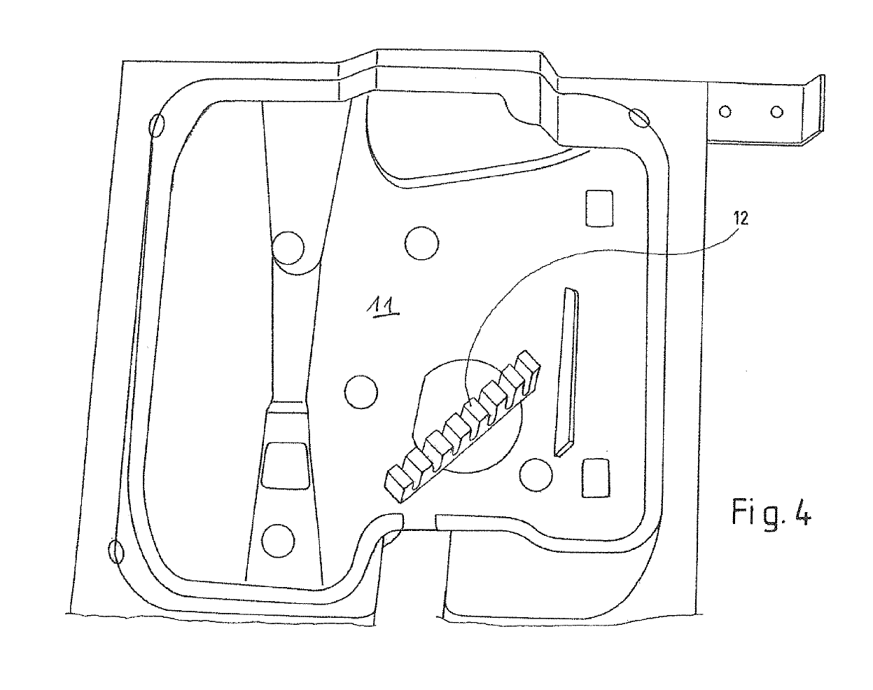

FIG. 4 illustrates a view into an open tool part 10 with a strip 12 arranged in the cavity 11 of the tool part 10.

The contour of the container 1 to be manufactured with the tool part 10 according to FIG. 4 does not correspond to the contour of the container 1 illustrated in FIG. 1.

### LIST OF REFERENCE SIGNS

1 container
2 container wall
2a container outer wall
2b container inner wall
3 reinforcing ribs
4 groove tracks
5 depressions
6 material bridges
7 projection
8 blow molding halves
9 preform
10 tool part
11 cavity
12 rib-shaped strip
13 grooves
14 webs

What is claimed is:

1-11. (canceled)

12. A container made from thermoplastic polymer with at least one inner reinforcing rib in a container wall, wherein the reinforcing rib is formed by at least one linear groove track in a container outer wall, the groove track extends over a length on the container outer wall, the groove track is formed by a multiplicity of depressions in the container outer wall, said depressions being arranged at a distance from one another, and wherein material bridges are provided between each of the depressions, said material bridges each having a smaller depth than the depressions, wherein the polymer of the container wall is accumulated in the region of the material bridges, and therefore the wall thickness of the container wall is greater in the region of the material bridges than in the region of the depressions.

13. The container as claimed in claim 12, wherein the wall thickness of the container wall is greater in the region of the material bridges than the wall thickness of the container wall outside the groove track.

14. The container as claimed in claim 12, wherein the depressions have a length and a width, and wherein the length is approximately one times to six times, preferably three times the width of the depressions.

15. The container as claimed in claim 14, wherein the material bridges have a length which is 0.3 times to 0.5 times the length of the depressions.

16. The container as claimed in claim 12, wherein the depressions are arranged at regular identical distances from one another.

17. The container as claimed in claim 12, wherein the material bridges have a length which is smaller than or equal to twice the wall thickness of the container outside the groove track.

18. The container as claimed in claim 12, wherein a plurality of reinforcing ribs, preferably in a form of a plurality of rectilinearly extending groove tracks which preferably cross one another or intersect are provided in the container wall.

19. A method for producing a container with the features of claim 12, wherein the container is obtained by extrusion blow molding of at least one preform made from thermoplastic polymer or by thermoforming a semi-finished product made from thermoplastic polymer, wherein the method comprises providing the preform, introducing the plasticized preform into a tool and deforming and shaping the preform within the tool, wherein at least one reinforcing rib in the form of a linear groove track is produced during the shaping of the container within the tool by means of at least one tool insert or a tool slide designed as a rib-shaped strip which protrudes into a cavity of the tool, wherein the strip has a multiplicity of grooves and webs, and wherein the webs produce depressions in the container outer wall and plasticized polymer is accumulated in the grooves, wherein the grooves correspond to the length of the material bridges, and in that the length of the grooves is dimensioned in such a manner that the wall thickness of the shaped container is greater in the region of the material bridges than the wall thickness of the container in the region of the depressions, and is preferably greater than outside the groove track.

20. The method as claimed in claim 19, wherein the length of the grooves is between 0.5 times and 4 times the wall thickness of the preform.
